(19) United States
(12) Patent Application Publication
(10) Pub. No.: US 2002/0073434 A1
(43) Pub. Date: Jun. 13, 2002

(54) System and method for supporting broadband communications services

(75) Inventor: Roger D. Pience, Scarborough, ME (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: MacroDyne Power LLC

(21) Appl. No.: 09/732,060

(22) Filed: Dec. 7, 2000

(51) Int. Cl. H04N 7/173

(52) U.S. Cl. 725/119; 725/130; 725/106

(57) ABSTRACT

A system, method and computer program product for supporting broadband communications services is provided, and more specifically, a broadband communications network interface unit and power source therefor, The broadband communications network interface unit of the present invention permits multiple services being provided to a subscriber to be combined and provided, supported, and controlled collectively by the network interface unit. Moreover, the present invention provides power for the network interface unit that permits lifeline services, such as telephone, to continue even during potential power outages to the system.

### FIELD OF THE INVENTION

The present invention relates to broadband communications, and more particularly, to broadband communications network interface units and power sources therefor.

### BACKGROUND OF THE INVENTION

Communications services have expanded over the last few decades and continue to increase exponentially. Individuals or entities that once received only telephone services are now receiving telephone services, cable television (“CATV”) services, and Internet access services, among other communications services. Until recently, each of these services has been provided individually. Communications services, however, have started to converge such that service providers that traditionally provided only a single service (e.g., CATV) now are working towards providing multiple services (e.g., CATV and internet access) over a single media. This move towards combining services is due, at least in part, to service providers trying to gain a greater market share or in order to expand the services that are being provided. There are difficulties, however, in combining services, including, for example, the separate services traditionally were provided and supported on different platforms. Also, different service providers, who typically have not cooperated, often provide the services with one another. Moreover, there are problems encountered by the individual service providers in supporting their individual service.

CATV systems are one example of such a service for which the provider faces challenges that affect the combining of services. Cable operators have constructed coaxial and fiber cable networks that are now available to over 96% of all homes in the United States, and more than 63 million households subscribe to CATV service. The technical capabilities of CATV systems are constantly being enhanced and expanded to provide cable operators new revenue streams and to provide customers upgraded systems and expanded features. For many years, the cable industry has attempted to implement methods to improve the cable-to-consumer electronics interface while protecting the cable operator's investment in programming. For example, the cable industry faces continuing challenges to eliminate the theft of cable signals by consumers. The revenue stream is affected by unacceptably high rates of programming theft. Many cable operators have addressed cable theft, at least in part, by encoding various CATV signals. However, any coded signal also must be decoded, and thus has resulted in CATV providers using a set-top converter box to decode signals at the subscriber's television which were encoded by the CATV provider before the signal was transmitted by the provider. Further, there is a continuing need and desire to offer new marketing flexibility (e.g., a variety of different CATV program packages) to consumers to assure added revenue potential for the CATV provider. Moreover, notwithstanding the need for a set-top converter box, there is a desire to eliminate the use of set-top converter boxes due in part to incompatibility between set-top boxes and consumers' electronics such as televisions or VCRs. Moreover, state of the art delivery and control of existing and new services is paramount to the survival of cable operators in the face of increased competition, such as the competition presented by satellite TV providers, internet TV providers, and telephone service providers able to deliver TV signals over the telephone lines.

Several prior art systems exist relating to the delivery and control of CATV service. For example, one specific type of controller is a CATV control apparatus, as described in U.S. Pat. No. 5,812,928, entitled “Cable Television Control Apparatus and Method with Channel Access Controller at Node of Network including Channel Filtering System” issued Sep. 22, 1998 in the name of inventors Watson, Jr. et al. The Watson '928 patent describes an apparatus for controlling access to television channels in a CATV system. The specific CATV control apparatus described in the '928 patent includes a controller located at a node external to a plurality of subscriber households, such as at the street. This controller identifies one or more channels to be forwarded to a specific subscriber serviced by the control apparatus. Although the Watson controller might alleviate the need for a set-top converter box, it does not provide any service other than CATV. Many other services currently offered to cable subscribers, by non-cable service providers, such as Internet service, voice and data services (phone and facsimile) are not capable of being provided, supported, or even controlled by the Watson cable control apparatus. Moreover, the use of the Watson controller is restricted to multiple CATV subscribers and therefore cannot be used to serve one CATV subscriber and the specific services being provided to that one CATV subscriber.

Another system is the subscriber network interface described in U.S. Pat. No. 5,805,591 to Naboulsi et al. The '591 patent relates to the transmission and distribution of telecommunication and CATV networks, but is limited in scope to those services that are carried via radio frequency (“RF”) analog or RF carrier modulated asynchronous transfer mode (“ATM”) data cells. The fact that the method of carrying the signal is limited effectively limits the use and capabilities of the system. Thus, there remains a need for an interface for a broadband communications network that can support and control various subscriber services and that is not limited in use and capabilities, such as that described in the Naboulsi et al. '591 patent.

Interface units similar to those described above may be located anywhere along the communications network. However, the unit requires power to function. Powering the units similar to the network interface described in the '591 patent is both expensive and technically difficult for a network provider such as a CATV provider. The problem is even greater for powering a broadband network interface unit communications controller located outside of a subscriber's home in an HFC or DSL network. One option for powering the controller is to use the network itself to provide power. However, the power requirement of the interface unit can be so significant that providing power from the network oftentimes is prohibitive.

An alternative power source for the network interface unit communications controller might be the electrical system in the subscriber's residence by means of an electrical connection to the subscriber's home via a low voltage transformer and coupler. Reliability of the residential electrical service, however, might not meet the quality-of-service standards required of and provided by the network. As is known, for example, often times the residential electrical service is subject to power outages that would affect the services provided by the network interface unit, such as the telephony service. Although such power outages generally do not significantly affect the subscriber, the loss of telephone service, and thus the use of emergency services like 9-1-1, can have severe implications for the subscriber of the service.

### SUMMARY OF THE INVENTION

It is, therefore, an object of the present invention to provide a broadband communications network interface for supporting a plurality of services to subscribers.

It is still another object of the present invention to provide a broadband communications network interface unit for supporting and controlling new broadband communication services, including but not limited to telephony, cable modems, interactive video and digital programming control and processing.

It is also an object of the invention to provide a network interface unit platform that is modular and is able to be configured and reconfigured as the customer requires additional services.

It is another object of the present invention to provide a highly reliable powering scheme for a broadband communications (HFC or DSL) Network Interface Unit (“NIU”).

These and other objects are provided according to the present invention that provides a broadband network communications interface unit that interfaces, supports, and controls broadband communications services. Support of telephony, cable modems, interactive video and digital programming control and processing are some of the features provided by the platform of the present invention. The network interface unit communications controller of the present invention (“NIU”), sometimes referred to as a residential gateway (“RG”), may be used to control multiple service functions being provided to a subscriber, such as those listed above, as well as facsimile service, telephone service, internet service, and cable television or satellite television service. These features share some of the current resources such as the power supply, memory, microprocessor and communications.

The present invention enhances cable system performance and profitability by reducing unauthorized programming use, increasing the viewer's freedom of selection of programming, even on an à la carte basis, and allowing for transactional based billing. The network interface unit provides a secure, yet unscrambled, signal transmission path of programming into the home, thereby eliminating the cable-to-consumer electronics equipment incapability problem. In addition, the technology of the present invention will enable media research companies to economically collect more accurate statistical information about program viewing than is currently available. The residential gateway platform of the present invention provides the cable operator the ability to offer the subscriber programming choices previously unavailable in a set-top converter box equipped cable system.

In addition to normal tiering functionality, the residential gateway controller is capable of providing individualized subscriber programming tiers and impulse pay-per-view while eliminating the in-house set-top converter box. In the present invention, the controller reacts to a subscriber request for a particular channel. The subscriber tuning the TV or VCR to that particular channel requests the channel. The controller recognizes the request and allows the chosen channel to pass through to the subscriber. The controller, as configured, is capable of regulating four independent frequencies or channels simultaneously for each subscriber's residence thus eliminating any equipment incapability problems.

The NIU is also capable of providing the user/subscriber with the functions of utility metering, electrical load management and home network connectivity. In this regard, the NIU employs a utility module that provides communication between the subscriber facility utilities (e.g. electrical, gas, water, etc.) and the entity providing these utilities. For example, the electric company that supplies electricity to the subscriber will be able to interface with the NIU to receive electrical metering data in real-time fashion. Additionally, the user/subscriber will have the capability through the NIU to control electrical load management to the various devices/hardware within the facility that warrant such. Currently this type of load management is limited to the control of the utility supplier (i.e. the electric company). The NIU also provides home networking connectivity allowing hardware within the home/facility to be networked for optimal functioning. Typically, the home network may utilize X10, CeBuss, Bluetooth or any other known or emerging standard to implement a home/facility type networking scheme.

The interfaces from the network to the customer according to the present invention are preferably housed on the exterior of a subscriber's residence or building, but the interfaces are not co-located with the network. By occupying a strategic location on the subscriber's business or residence, the present invention provides modular distributed intelligence at a physically secure network location. The “off-premise” platform not only provides for all of the necessary functionality of secure signal delivery and full customer control over their programming choices, but provides shared resources for further system enhancement.

The common functions referenced above, such as power supply, communications, and some microprocessing are built into a back plane into which the service modules connect. The network interface unit can be used in an HFC or xDSL broadband network to facilitate and control various video, telephony, and data services into a residence.

These and other features also are provided according to the present invention wherein power is supplied to the network interface unit by a primary power supply, such as from the residential electrical system, and the network power is multiplexed or mixed with a secondary power supply, so that during electrical power outages or any other losses of power, only that amount of power required to operate specific services supported by the NIU, such as “life-line” services, i.e., the telephone service or alarm services, is taken from the network powering system. This multiplex powering scheme may be used with any communications network device where it is critical to maintain operation through the loss of a power source.

According to the present invention, a sensor is provided that detects the presence of an electrical signal from a primary power source, such as the residential electrical system. If the sensor detects an absence of power or a loss of power from the primary power source, the sensor controls a switch to select power from a secondary power source such as the network (rather than from the primary power source such as residential electrical system). The sensor also places on hold any number of the plurality of services supported by the network interface unit, except for specific services, such as “life-line” services, i.e., telephony services. The sensor also detects the restoration of electrical power to the primary power supply, e.g., the subscriber's residence, and controls the powering selector switch to return to the normal powering state, thereby powering all modules from the primary power source, e.g., the residential electrical system. The sensor and power switch are solid state devices.

### BRIEF DESCRIPTION OF THE DRAWINGS

While some of the objects and advantages of this invention have been set forth above, other objects and advantages will appear as the description proceeds in conjunction with the drawings, in which:

FIG. 1 is a block diagram of a communications network embodying the Network Interface Unit (NIU), in accordance with an embodiment of the present invention.

FIG. 2 is a block diagram of a communications network embodying the Network Interface Unit having a wireless interface between the NIU and some of the networked devices, in accordance with an embodiment of the present invention.

FIG. 3 is a block diagram of a communications network embodying the Network Interface Unit having a wireless interface between the NIU and all of the networked devices, in accordance with an embodiment of the present invention.

FIG. 4 is a block diagram of the communications network embodying the NIU and detailing the architecture comprising the headend and related system management systems, in accordance with an embodiment of the present invention.

FIG. 5 is a block diagram of the Network Interface Unit highlighted the various modules of the device, in accordance with an embodiment of the present invention.

FIG. 6 is a block diagram of an analog video embodiment of the Network Interface Unit highlighting the various modules, in accordance with an embodiment of the present invention.

FIG. 7 is a detailed block diagram of an analog video embodiment of the Network Interface Unit in a hybrid fiber coax (HFC) network environment, in accordance with an embodiment of the present invention.

FIG. 8 is a detailed block diagram of an analog video embodiment of the Network Interface Unit in a pure fiber network environment, in accordance with an embodiment of the present invention.

FIG. 9 is a spectrum diagram of the Network Interface Unit dynamic filter and modulator, in accordance with an embodiment of the present invention.

FIG. 10 is a detailed block diagram of the dynamic filter single conversion embodiment of the Network Interface Unit, in accordance with an embodiment of the present invention.

FIG. 11 is a block diagram of the dynamic filter double conversion embodiment of the Network Interface Unit, in accordance with an embodiment of the present invention.

FIG. 12 is a detailed block diagram of a digital video embodiment of the Network Interface Unit in a hybrid fiber coax network environment, in accordance with an embodiment of the present invention.

FIG. 13 is a detailed block diagram of a digital video embodiment of the Network Interface Unit in a fiber network environment, in accordance with an embodiment of the present invention.

FIG. 14 is a block diagram of a digital video embodiment of the Network Interface Unit providing for multiple video outputs, in accordance with an embodiment of the present invention.

FIG. 15 is a block diagram of the Network Interface Unit and the powering scheme therefor, in accordance with an embodiment of the present invention.

FIG. 16 is a flow chart showing the method steps of the powering scheme of the present invention, in accordance with an embodiment of the present invention.

FIG. 17 is a circuit diagram of the sensor/switching mechanism of the present invention, in accordance with an embodiment of the present invention.

### DETAILED DESCRIPTION OF THE ILLUSTRATED EMBODIMENTS

The present invention will now be described more fully hereinafter with reference to the accompanying drawings, in which a preferred embodiment of the present invention is shown. This invention may be embodied, however, in many different forms and should not be construed as limited to the embodiments set forth herein; rather, this embodiment is provided so that this disclosure will be thorough and complete, and will fully convey the scope of the invention to those skilled in the art. Like numbers refer to like elements throughout.

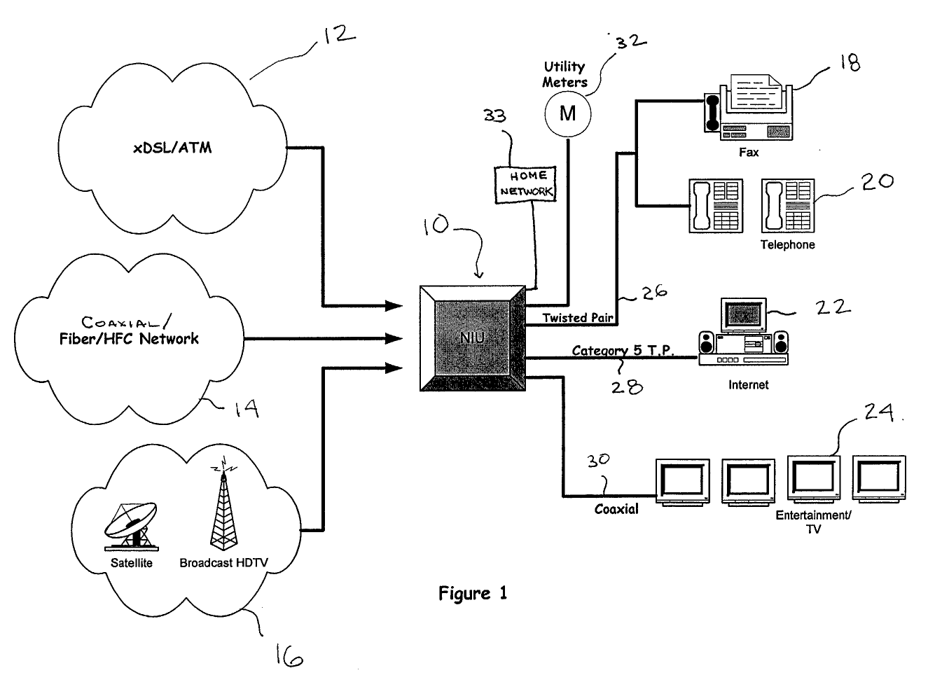

Referring now to FIG. 1, in accordance with an embodiment of the present invention, the Network Interface Unit 10 (or Residential Gateway) will be discussed. FIG. 1 generally shows a composite of the entire communication system from the network providing the subscriber services at one end of the system to the services being provided in the subscriber's home at the other end of the system. The Network Interface Unit (NIU) 10 interfaces with various possible network services, including a xDSL 12, a Coaxial/Fiber/HFC 14, and/or a Satellite/Broadcast HDTV 16.

The xDSL (Digital Subscriber Line) 12 network services are generally employed for communicating telephony services, such as voice and facsimile. More recently, these types of networks have additionally provided Internet or other network access service and video service but are limited in bandwidth capabilities. Typically, multiplexed twisted pair is the media of choice for establishing communication between the xDSL network services and the Network Interface Unit 10, although other communication media may also be used and is within the inventive concepts herein disclosed.

The Coaxial/Fiber/HFC (Hybrid Fiber Coax) 14 network services are generally employed for communicating video, in the form of cable television. More recently, these types of networks have additionally provided Internet or other network access service and voice service, such as telephone. Typically, as the name infers, coaxial cable, optical fiber or a hybrid is the media of choice for establishing the connection between the network and the Network Interface Unit 10.

The Satellite/Broadcast HDTV 16 network services are generally employed for communicating video feeds, internet or other network access services and the like. These services use wireless communication as the media for establishing connection between the network and the Network Interface Unit 10.

It should be noted that the network services shown in FIG. 1 are by way of example and therefore the listing is not exhaustive. The Network Interface Unit can accommodate communication with alternative network services and such services shall be considered within the realm of the current invention. Therefore, while the use of an HFC network service is perhaps most common in use at this time, any network service can be made compatible with the Network Interface Unit 10 of the present invention.

On the other end of the Network Interface Unit 10 are the plurality of services capable of being supported by the Network Interface Unit 10, including facsimile services 18, telephone services 20, internet or other computer related network services 22, and entertainment/TV services 24. These services are shown by way of example and other services capable of being used by a subscriber also may be supported by the Network Interface Unit 10. While the FIG. 1 depictions shows specific connections leading from the Network Interface Device to the services, it will be obvious to those of ordinary skill in the art that the connections to these services from the Network Interface Unit can be supported by any one of the connections shown; a twisted pair connection 26, Category 5 twisted pair connection 28, or a coaxial cable connection 30, whichever is appropriate and known in the industry to be used for the particular service being supported.

The Network Interface Unit 10 typically will be located in close proximity to the dwelling occupied by the subscriber. For example, in the instance where the subscriber is individual the NIU will typically be located at the individual's residence or in the instance where the subscriber is a business the NIU will typically be located at the business property. In one embodiment, the Network Interface Unit 10 is located on the exterior of the residence or place of business. Alternatively, the Network Interface Unit can be located inside the residence or place of business or even at a location away from the facility, such as at a street location.

Also illustrated in FIG. 1 is the residential Utility Meter 32 and Home Network 33 that are in communication with the Network Interface Device 10 for the purpose of supplying power load management and/or programmability to the various networked devices/hardware within the residence or place of business. Additionally the communication with the NIU allows for the device to access utility meter readings (electrical, water, gas or the like) and communicate these readings back to the utility provider through the network system.

Additionally (not shown in FIG. 1), the Network Interface Device 10 may be in communication with a facility security monitoring device for the purpose of providing programmability/functionality to the security monitoring system and providing security monitoring data back to the security monitoring service provider through the network.

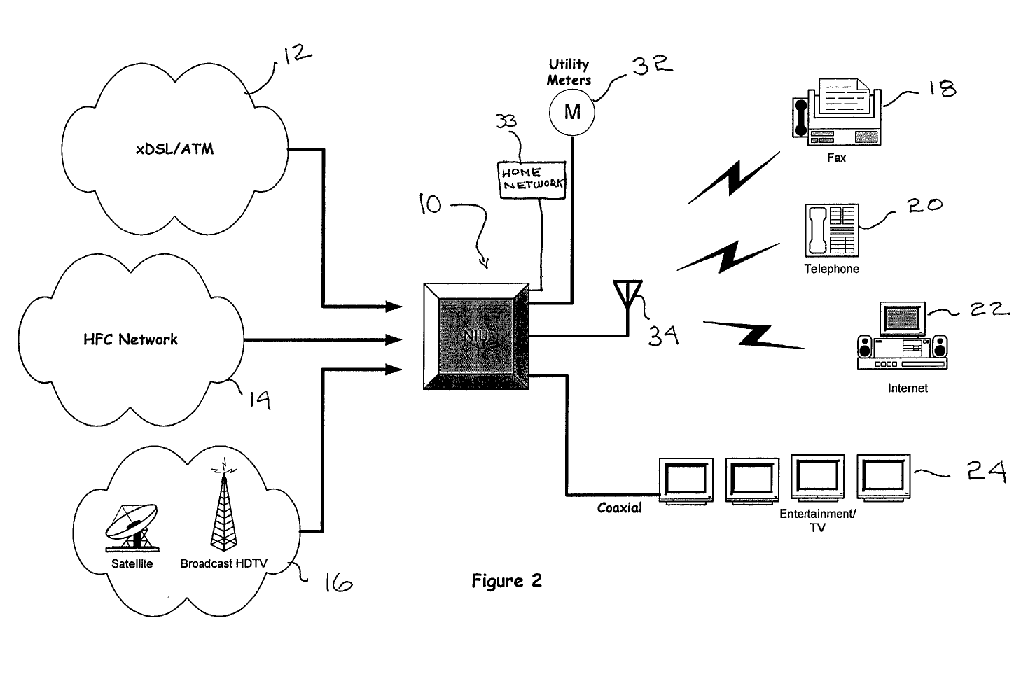

Referring now to FIG. 2, an alternative Network Interface Unit 10 is described, in accordance with an embodiment of the present invention. FIG. 2 generally illustrates the communications network as shown in FIG. 1 with some alternative features. In FIG. 2, the connection to the facsimile 18, telephone 20, and internet 22 services are connected to the Network Interface Unit through a radio frequency signal or other wireless connection 34 rather than by the hardwired connections 26 and 28 shown in FIG. 1. The wireless connection will typically be an antenna that serves as the transmission and reception point for wireless communications between the NIU and the devices, and vice versa. The wireless connection can be incorporated into the NIU or it can be remote from the NIU.

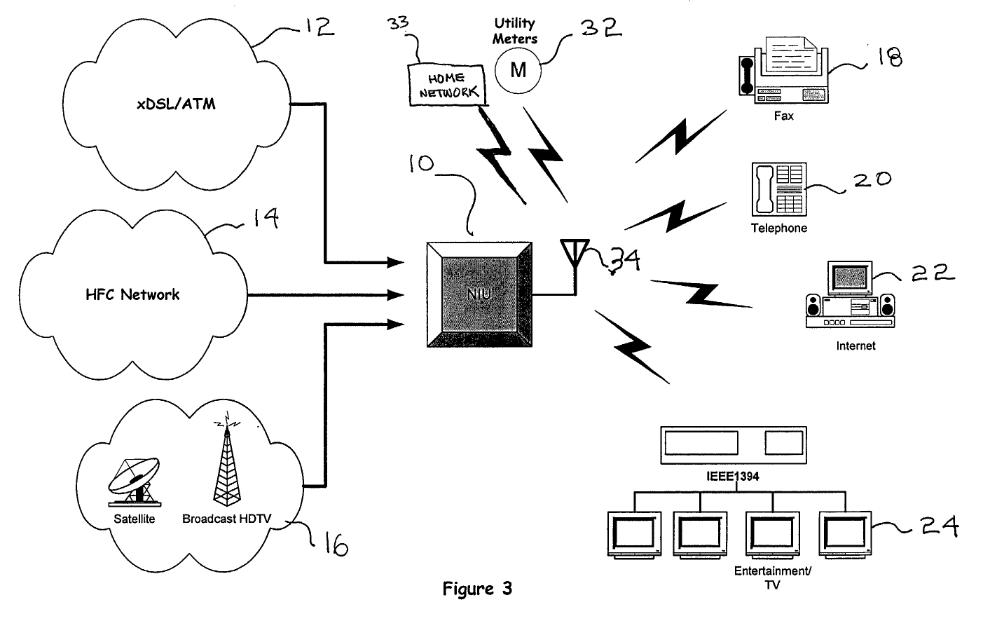

Moreover, as illustrated in FIG. 3 an alternate embodiment of the present invention, the utility meters 32 and the entertainment/TV services 24 also may be connected via radio frequency signal or other wireless connection 34. In addition, the entertainment/TV services 24 may require the use of a controller 36 to route the RF video feed to multiple entertainment/TV units throughout the facility. An example of such a controller is an IEEE 1394 server that is known to those skilled in the art and readily available from various sources.

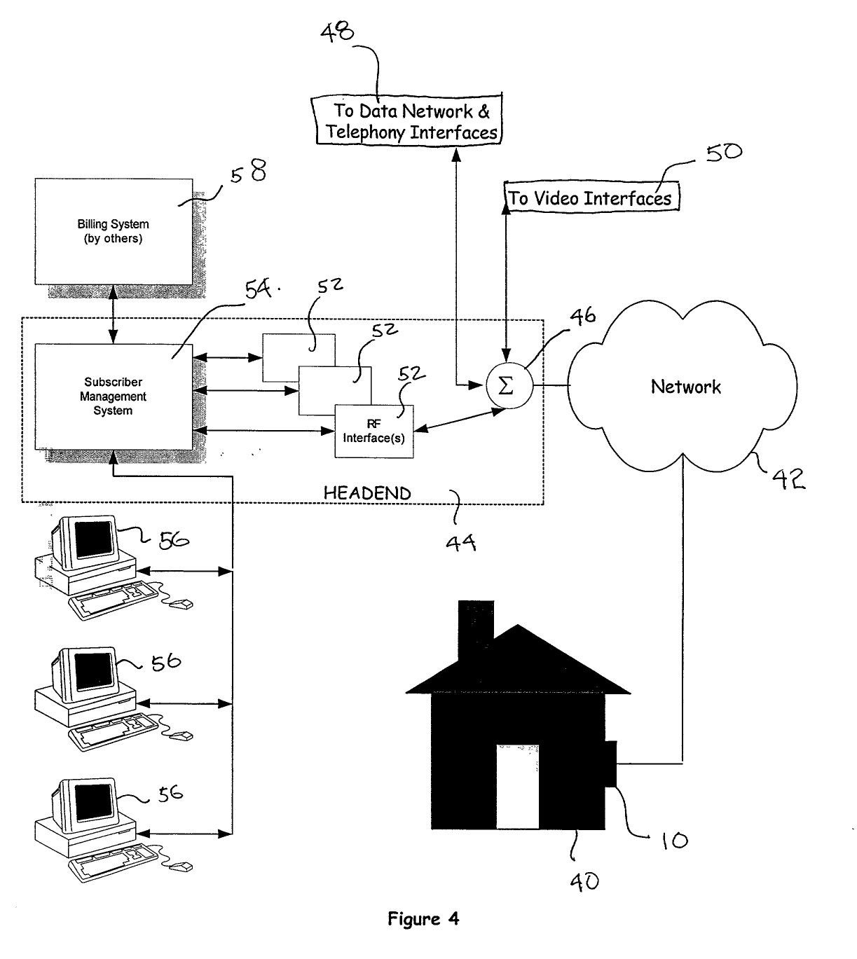

Referring now to FIG. 4, the Network Interface System is illustrated in accordance with a further embodiment of the present invention. The Network Interface Unit 10 is shown attached to the exterior of a residence 40. The NIU is in communication with network 42 and the network is in communication with a service provider (Cable Company, Telco or the like), denoted here as the headend 44. The network in this context is the delivery media, such as twisted pair, wireless, coax, HFC, fiber only or the like.

The head end of the Residential Gateway System includes a combining network 46, typically a series of passive hybrids that serves as an connection between the headend and the various service interfaces, such as the data network & telephony interfaces 48 and the video interfaces 50. The headend also includes a series of RF interfaces 52 that are in communication with the combining network and a subscriber management system 54. The RF interfaces are bi-directional data transceivers that serve to convert the data stream for the purpose of managing the individual NIUs. A typical RF interface will comprise a quadrature phase shift transceiver (i.e. BPSK or QAM) capable of translating data coming from the NIU to the subscriber management system and data coming from the subscriber management system to the NIU.

The subscriber management system is implemented in a software module and provides for management of the accounts of the NIU subscribers. Typically, the subscriber management system will be in communication with a series of hosts 56 that allow for customer service representatives to input, in real time, functional changes to individual NIUs based upon subscriber service selection, NIU updates/maintenance and the like. Additionally, the subscriber management system may be in communication with a billing system module 58 that provides the system with a means for billing subscribers based on numerous billing schemes, such as per-use, time-of-the-day, time-of-the-week schemes or the like. As depicted, the customer service manned hosts and the management of the billing system may be external to the headend 44 or they may be located within the headend.

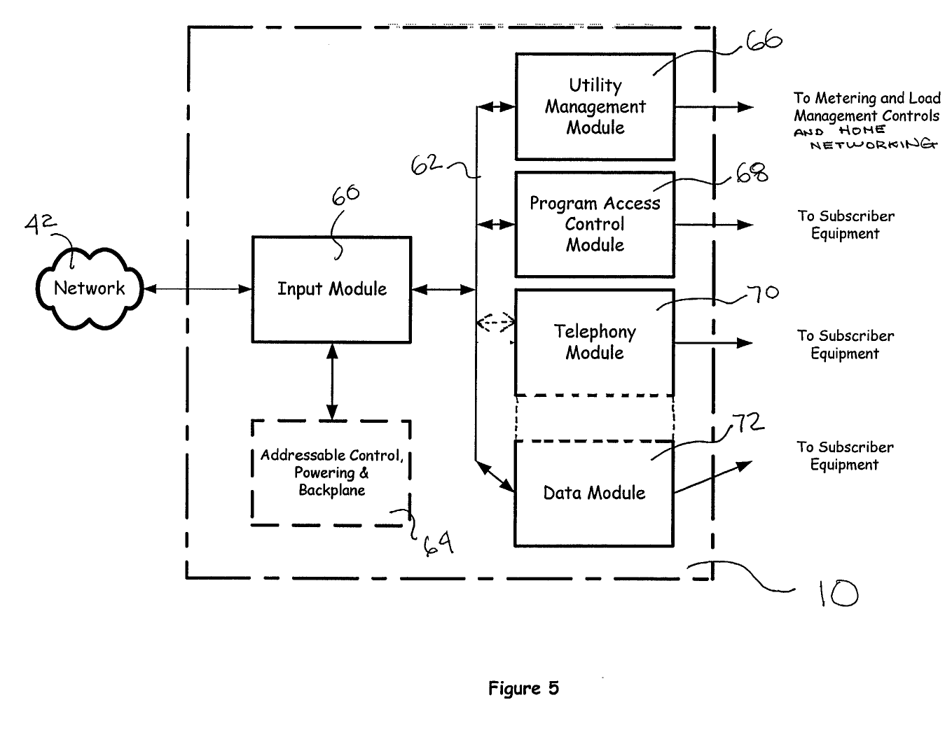

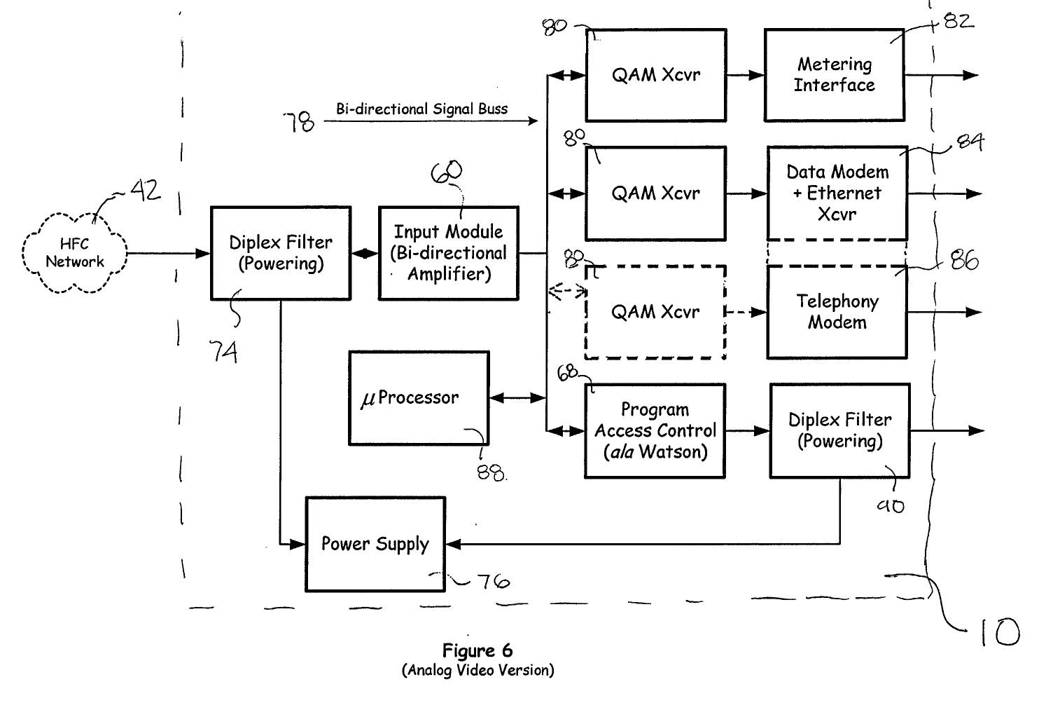

Referring now to FIG. 5, there is illustrated a block diagram of the components of the NIU 10, which is in communication with the network 42. The NIU includes an input module 60 that is in communication with the network and accepts the signal of the various services supported by and carried by the network. The input module 60 receives and transmits data coming from and going to the network via coax, fiber, HFC, satellite, twisted pair, broadcast or any other compatible communication media. In one embodiment of the invention the input module may be interchangeable so that it may support any communication media that a subscriber desires to employ. The input module serves to convert data so that is it may be transmitted on a bi-directional signal information bus 62 and communicated in a useable format to the other modules in the NIU. The input module is controlled and powered by the addressable control, powering and back plane 64. After the input module properly converts the signal it feeds the signal to one of the various services including the utility management module 66, the program access control module 68, a telephony module 70 and a data module 72.

The utility management module 66 communicates with the utility metering devices, load management controls, security devices, home networking scheme and other like devices associated with the residence or place of business. Additionally, the utility management module comprises the necessary devices for the powering scheme of the Network Interface Unit. The program access control module 68, the telephony module 70, and the data module 72 also are in communication with the input module and the corresponding subscriber equipment.

The Program Access Control (PAC) module 68 serves to control the video portion of the data communication by providing the subscriber with channel options and responding to the subscriber inputs related to these options. The program access control module is generally of the type described in detail in the Watson '928 patent. The contents of that patent is herein incorporated by reference as if setforth fully herein. The telephony module 70 and the data module 72 are in communication with the input module and the associated subscriber equipment and control the telephone and data services being provided to the subscriber. In this regard, these modules are capable of addressing, metering and QOS status monitoring the subscriber's devices. The telephony module and the data module may be individual modules within the NIU or they may be combined into a single module that communicates with both the telephony hardware and data (i.e. computer) hardware within the subscriber's facility.

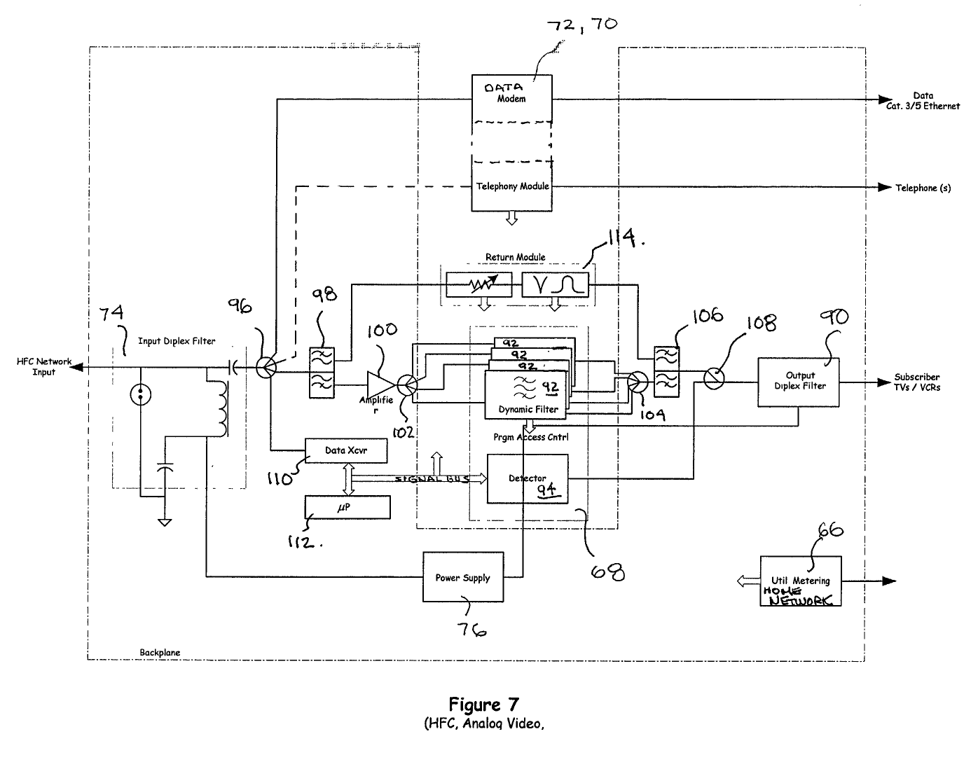

Referring now to FIG. 6, an alternate embodiment of the NIU device 10 is depicted in block diagram format. This analog video version embodiment differs from the embodiment shown in FIG. 5 in that it provides for a variance in the network data transport stream and results in a more efficient use of bandwidth. In this embodiment of the present invention, the network 42, which in this instance is an HFC network, is in communication with a diplex filter 74. The diplex filter is in electrical communication with the input module 60 and a power supply 76. The power supply is part of the addressable control; powering and back plane 64 described and shown in FIG. 5.

In this embodiment of the invention, the input module 60 is typically a bi-directional amplifier capable of amplifying the signal carried by and to the HFC network 42. The input module 60 is in electrical communication with a bi-directional signal bus 78, which is comprised of a plurality of quadrature amplitude modulated (QAM) transceivers 80 and the program access control module 68. The QAM transceivers provide for an alternate means of distributing data down an HFC network by combining the data streams at the headend and modulate them on single QAM carrier. The result of implementing the QAM transceiver and the filtering scheme is better overall data transport efficiency. The metering interface 82 and associated QAM transceiver 80 correspond to the Utility Management Module 60 shown in FIG. 5. Accordingly, the data modem and Ethernet transceiver 84 and associated QAM transceiver 80 correspond to the Data Module 72 and the telephony modem 86 and associated QAM transceiver 80 correspond to the Telephony Module 70. As previously discussed, the Data Module and the Telephony Module may be combined into a single module, in such an embodiment a single associated QAM transceiver would be required and the data modem and Ethernet transceiver 84 and telephony modem 86 would encompass the combined module. The Program Access Module is generally equivalent to the Module described in the FIG. 5 embodiment and, hence, is generally of the type described in detail in the previously incorporated Watson '928 patent. Each of the QAM transceivers and associated modular components, along with the Program Access Module are controlled by an auxiliary microprocessor 88 that is in communication with these components via the signal bus 78. A second diplex filter 90 is in communication with the program access control module 68 for filtering out bandwidth of undesirable signals as they are transported to associated video hardware at the subscriber's facility.

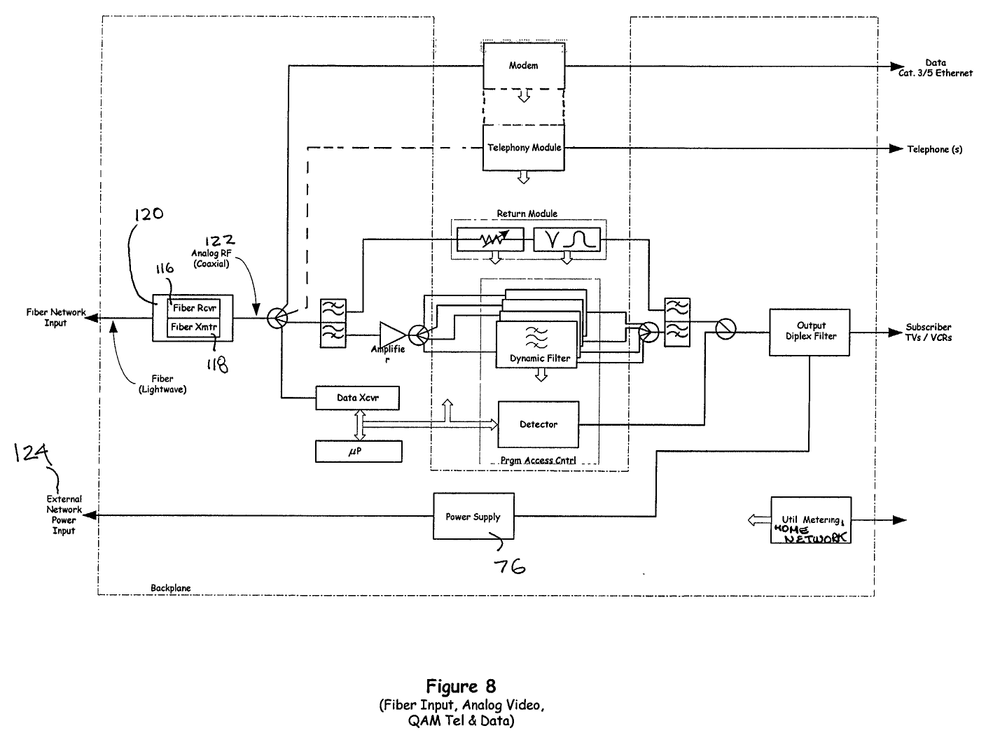

Referring now to FIG. 7, a more detailed block diagram of the analog Network Interface Unit is shown, in accordance with an embodiment of the present invention. In particular, the program access control 68 includes multiple dynamic filters 92, for filtering the signal being provided from the HFC Network and a detector 94, which is detects oscillator signals coming from the video hardware at the subscriber's facility.

An input diplex filter 74 siphons off power coming from the HFC network and provides surge protection. The input diplex filter will typically comprise a low pass filter operating at power line frequencies. The output diplex filter 90 serves to bring in power from the subscriber's facility and provides surge protection. The output diplex filter will typically comprise a low pass filter operating at power line frequencies.

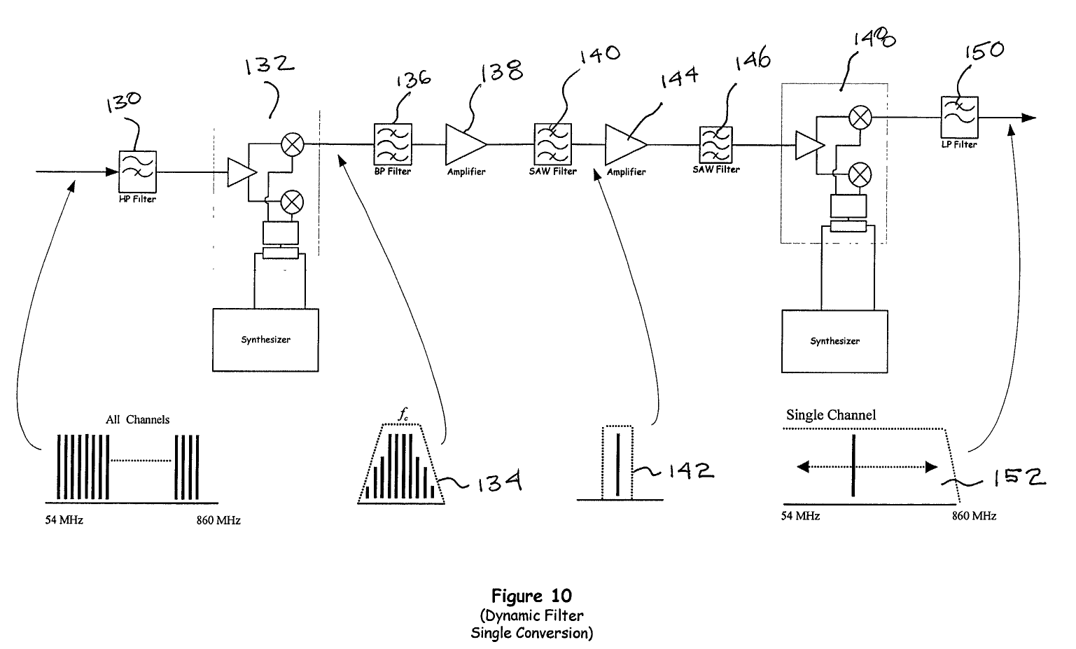

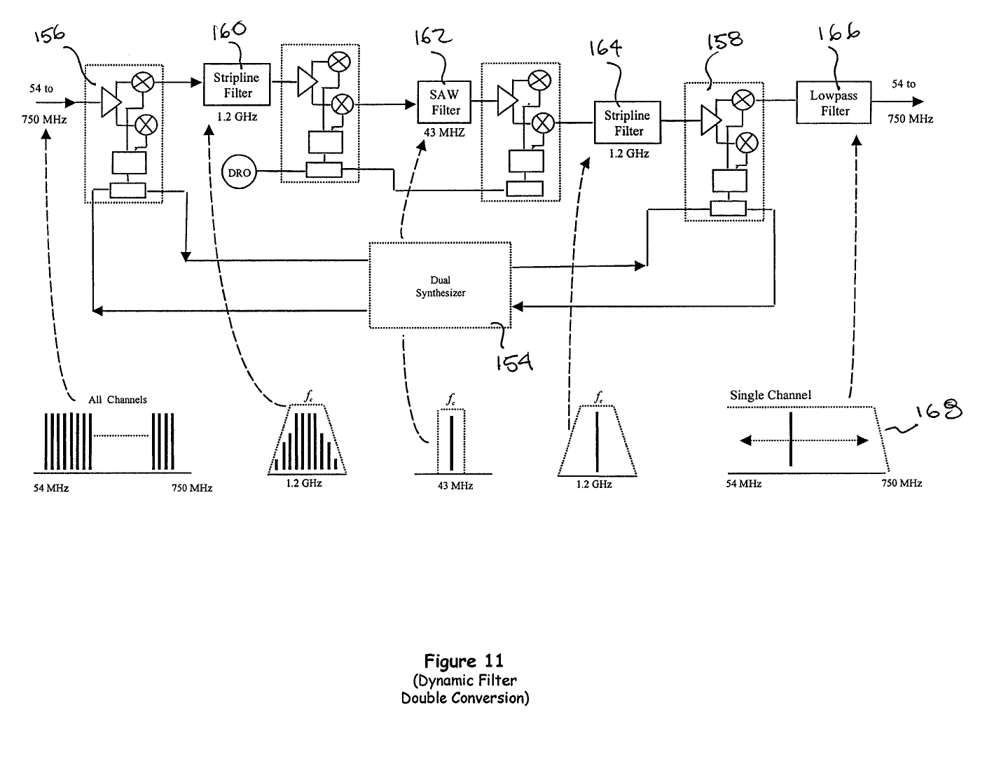

The input diplex filter is in communication with splitter 96, typically a passive hybrid splitter that divides the RF signal. A first output of the splitter is in communication with the data module 72 and a second output is in communication with the telephony module 74. In one embodiment of the invention, the data module and the telephony module may be combined into a single module (as shown in FIG. 7) that supports both telephony and data applications. In such an embodiment in which these modules are combined a single output would lead from the splitter 96 to the combined module. An additional output of the splitter is in communication with filter 98, typically a high pass/low pass filter that serves to pass specific high signals, generally those signals above 50 MHz, on to the amplifier 100. The amplifier, typically a generic RF amplifier serves to increase the signal prior to the signal entering the program access control module 68. The amplified signal then passes through splitter 102, typically a passive hybrid splitter that serves to divide the signal for subsequent dynamic filtering. The dynamic filtering 92 scheme serves to control the filtering of video channels into the subscriber's facility. The dynamic filtering scheme is described in more detail in accordance with the forthcoming discussion of FIGS. 10 and 11.

The dynamically filter signals are recombined using a reverse splitter 104, a passive hybrid splitter that is placed in an opposite direction in relation to the two previous splitters described previously. The reverse splitter is in communication with a second filter 106, typically a high pass/low pass filter that serves to provide the highest attenuated portion of the signal to coupler 108. The coupler is in communication with the output diplex filter 90 that serves to combine the signal and the power for surge protection purposes.

The detector 94 serves to detect the local oscillator signals coming from the subscriber's video hardware (TVs, VCRs, DVDs and the like). The detector allows the subscriber's video hardware to send data back through the HFC network. The signals coming from the subscriber's hardware pass through the output diplex filter 90 and the lowest attenuated portion of the directional coupler 108. The isolation provided by the coupler, typically in the range of 50 dBs of isolation, provides a magnitude lower noise value to the detection scheme, thus providing for a marked improvement over the detection scheme as described in the Watson '928 patent. The detector is in communication with the data transceiver 110 that is a companion unit to the data transceivers found at the headend, described in FIG. 4. The data transceiver serves to translate the data coming from the detector prior to transmission out to the HFC Network. The data transceiver and detector are controlled by the accompanying microprocessor 112.

Additionally, filter 106 provides low pass signals, in the range of 5 to 42 MHz signals to the return path module 114. The return path module is required for those subscriber video hardware devices that implement interactive services. The return module comprises addressable notch filter, a bandpass filter and an attenuator to compensate for any extraneous signal coming from the subscriber's facility.

As shown in FIG. 7, the Utility Module 66 is isolated from the functionality of the other modules and will typically use a separate hardwire network. The Utility Module will be in communication with the signal bus shown in FIGS. 5 and 6.

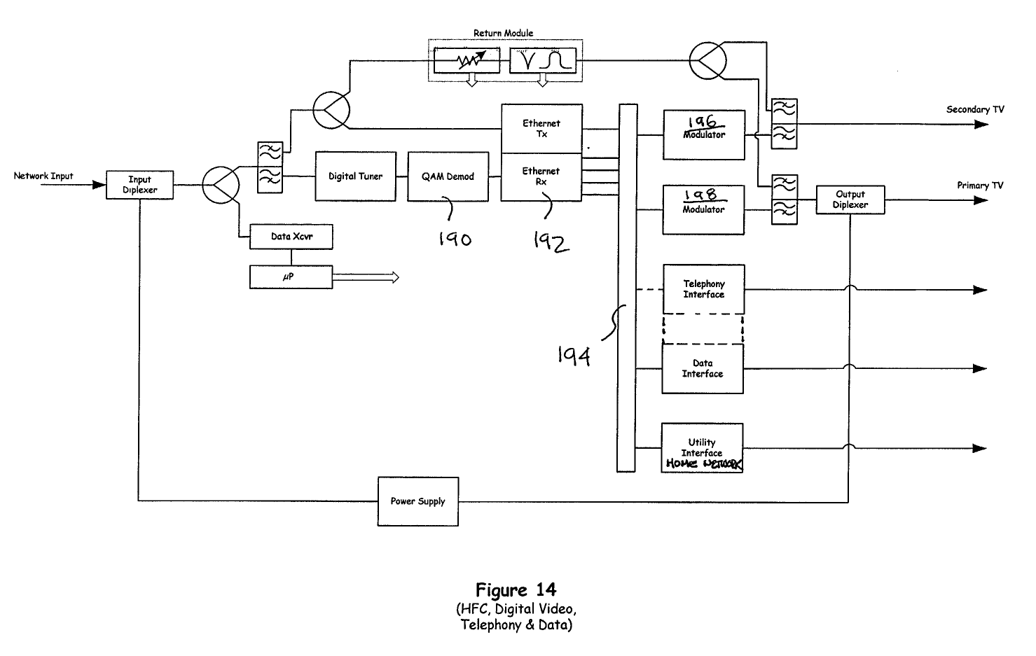

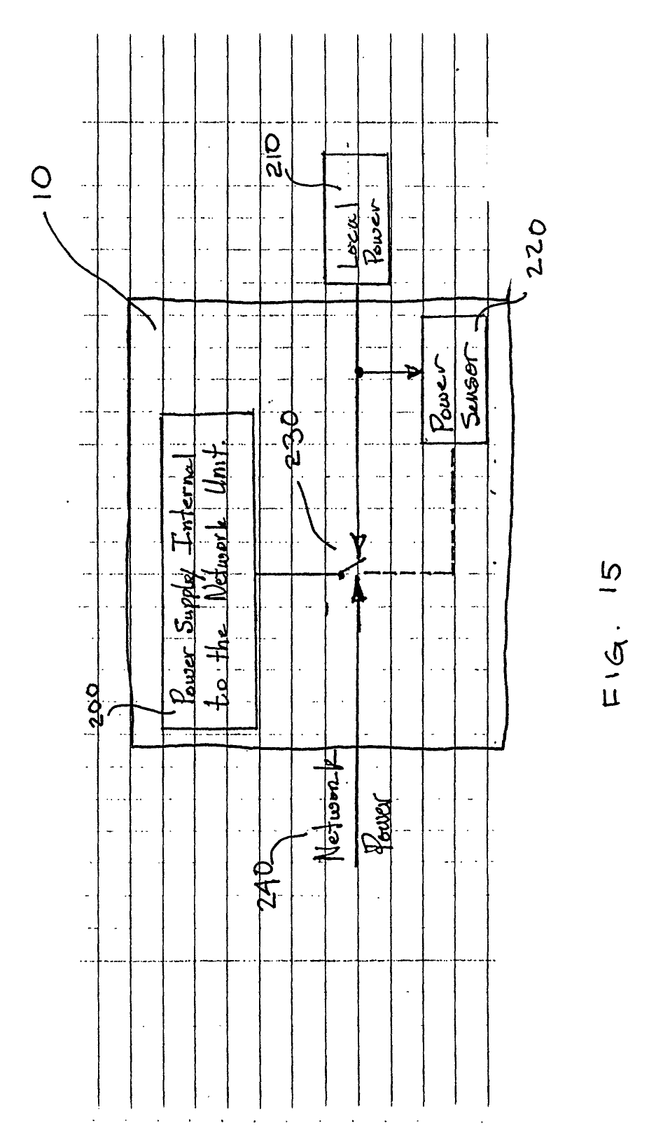

Referring now to FIG. 8, another embodiment of the NIU invention is shown, wherein the network is a fiber network. In this regard, there is a fiber receiver 116 and fiber transmitter 118, together forming a data transceiver 120 that is capable of receiving an optical signal from the fiber network and transmitting an RF signal onto an analog RF (coaxial) transmission line 122. Conversely, the data transceiver is capable of receiving a RF signal coming from NIU and converting it to an optical signal for transmission out to the fiber network. Since optical fibers are incapable of transmitting electrical signal the power supply 76 is in communication with an external network power input that allows for the NIU to receive back-up power from the network in the instance where the primary power source coming from the subscriber's facility fails to supply power. The detailed discussion surrounding the back-up power capabilities of the present invention are forthcoming in the discussion related to FIGS. 14-16.

Referring to FIG. 18. shown is an embodiment of a detector 94 that can be used in conjunction with the program access control module 68 of FIG. 7 and 8, in accordance with an embodiment of the present invention. The illustrated embodiment is a digital implementation of a detector that provides for a faster. more sensitive detector than analog counterparts. The detector shown is capable of theoretical detection down to about −164 dBm with significant interferors. The RF signal is inputted into an amplifier 400 that provides an amplified output signal to a first mixer 402. The first mixer is in communication with and provides an input signal from an oscillator 404 and an output signal to a low pass filter 406. The low pass filter is typically comprised of a conventional linear components. The low pass filter is in communication with and provides output to an analog to digital (A/D) converter 408 that converts the signal from an analog format to a digital format. The A/D converter is in communication with an outputs a signal to a first Finite Impulse Response (FIR) filter 410. The FIR filter is typically implemented in conventional digital signal processing (DSP) components and provides for refined digitizing and filtering of the signal.

The first FIR filter 410 is in communication with and outputs to the spread spectrum portion of the detector 94. The spread spectrum portion of the detector will comprise a second mixer 412 that is in communication with and input a processor 414 and a second FIR filter 416. The processor provides the means to control and change the characteristics of the digital signal as dictated by the application and/or desired channel. The second FIR filter may comprise a digital DSP or any other implementation of a FIR filter may be employed. The processor and second FIR filter are in communication with and provide signals to the third mixer 418. The third mixer combines the signals being outputted by the processor and the second FIR filter and provides a combined output to the digital to analog (D/A) converter 420 where the signal is converted back to analog format for subsequent comparison to determine pressure of the signal. The detector shown in FIG. 18 is not limited in use to the detection scheme shown in FIGS. 7 and 8, but rather has widespread applicability for many other small signal detection applications such as radio astronomy. Additionally, the detector shown in FIG. 7 and 8 may also be embodied in an analog implementation.

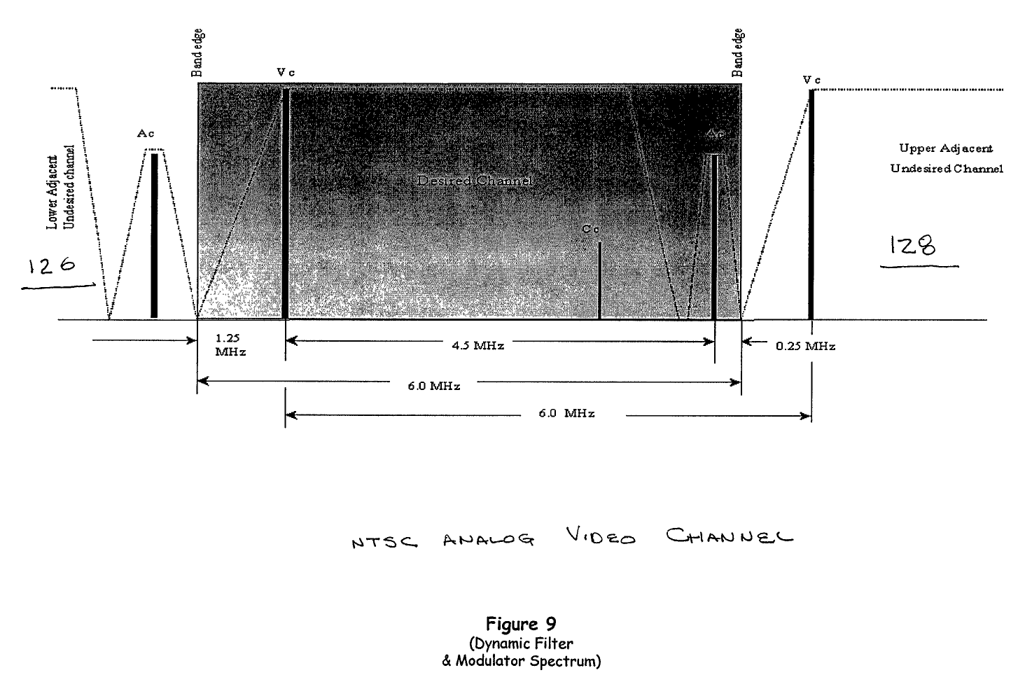

FIGS. 9 through 11 illustrate in detail the use of the dynamic filter and several embodiments thereof, which can be used to filter out undesired channels. Specifically, with respect to FIG. 9, the result of the dynamic filter and modulator spectrum is shown. Shown is the spectrum of signals that is input through filtering process. On the left end of the spectrum shown in FIG. 9, are the lower adjacent undesired channels 126, and on the right end of the spectrum are the upper adjacent undesired channels 128. The dynamic filter of the present invention in the middle of the spectrum is the approximately 6 megahertz wide band edge (the shaded area in FIG. 9) which permits the desired channels to pass through from the signal of the network to the subscriber's system. The filter is addressably tunable to select any one channel.

FIG. 10 illustrates the detailed mechanics of the dynamic filter, in accordance with an embodiment of the present invention that utilizes a single conversion to pass the desired channels to the subscriber. As shown in FIG. 10, the input to the dynamic filter is a signal carrying all channels varying from approximately 54 megahertz to approximately 860 megahertz. This signal is the input to a high pass filter 130, the output of which is the input to a synthesizer and Hetrodyne converter 132. The output of the Hetrodyne converter is a particular band of channels 134, which is then inputted into a series of devices, including a band pass filter 136, an amplifier 138, and a saw filter 140, the output of which is a single channel 142. The single band of channels is then inputted into a second amplifier 144, a second saw filter 146, a second synthesizer and Hetrodyne converter 148, and a low pass filter 150. The output of the low pass filter 150 is a single channel 152, which represents the desired channels provided to the subscriber's system.

FIG. 11 illustrates the detailed mechanics of the dynamic filter, in accordance with an embodiment of the present invention that utilizes a double conversion to pass the desired channels to the subscriber. In this embodiment, a dual synthesizer 154 is implemented, which is in communication with the first Hetrodyne converter 156 and fourth Hetrodyne converter 158. The double conversion also utilizes a strip line filter 160, a saw filter 162, and a second strip line filter 164. The final stage of the double conversion is a low pass filter 166, the output of which is the single channel 168 representing the desired channels being sent to the subscriber's system.

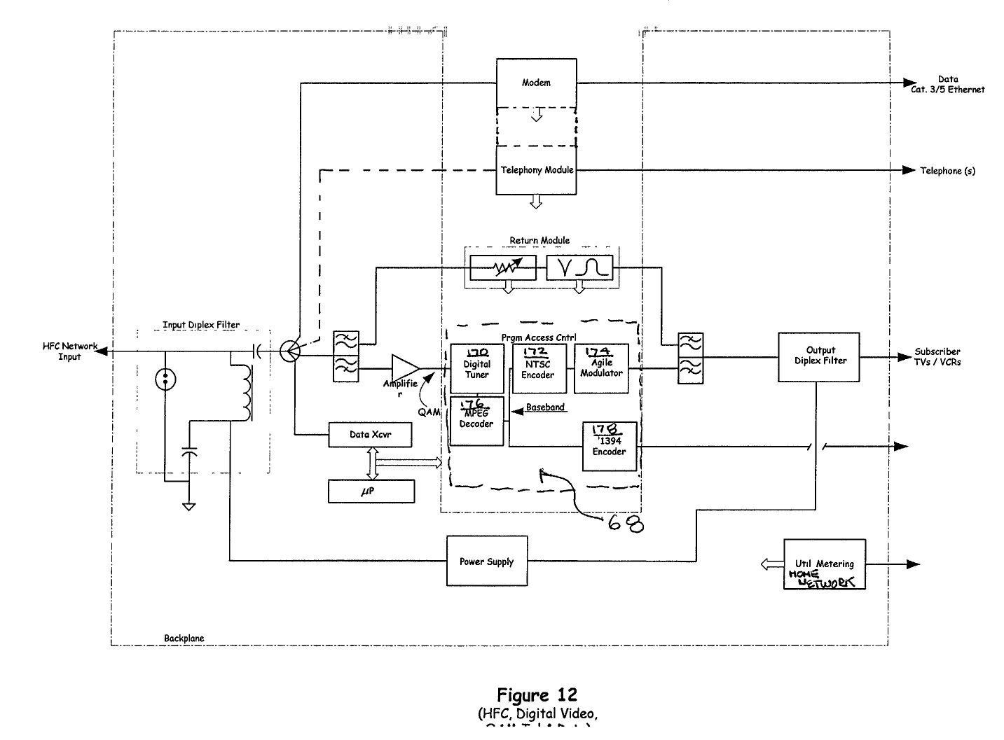

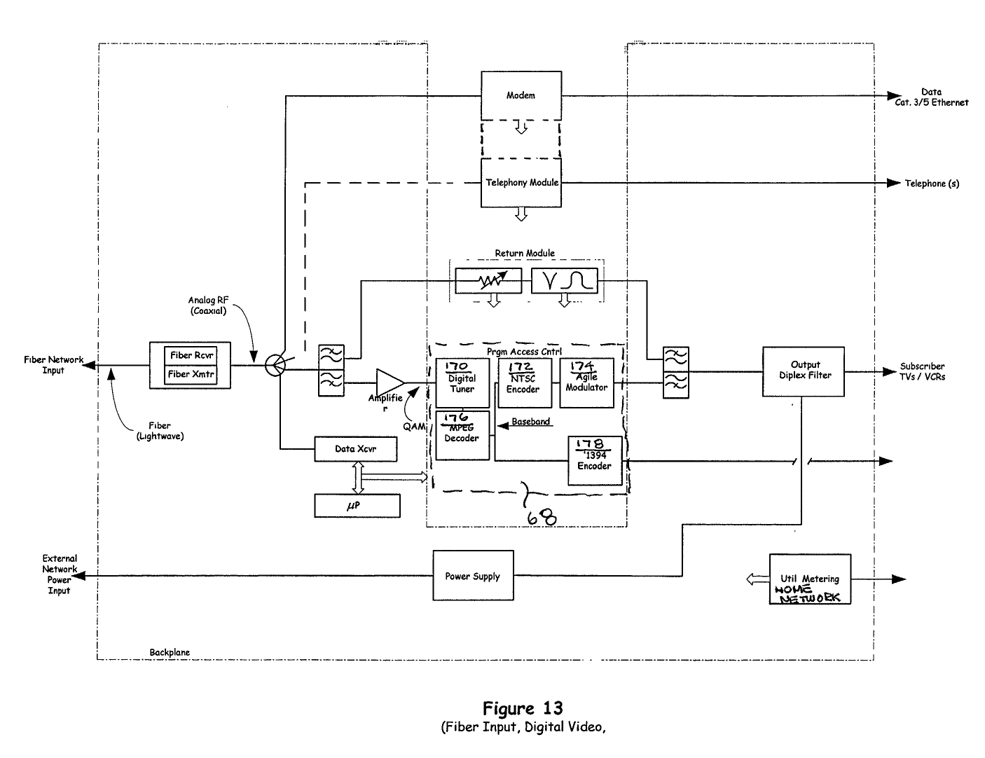

FIGS. 12 and 13 illustrate an additional embodiment of the present invention in terms of a Program Control Module within an NUI implemented for a digital schemes as opposed to the analog schemes shown in corresponding FIGS. 7 and 8. FIG. 12 depicts the digital scheme in the HFC network environment and FIG. 13 illustrates the digital scheme in the in pure fiber environment. The Program Control Module 68 comprises a digital tuner 170, an NTSC encoder 172, an agile modulator 174, an MPEG decoder 176, and a decoder 178.

FIG. 14 is an alternate embodiment of the present invention that allows the Program Control Module of the NIU to use a different transport scheme to provide multiple video outputs. A single QAM demodulator 190 communicates the video signal to a xGigabit Ethernet receiver 192 that in turn communicates with a data bus 194, such as a PCI data bus or the like. The data bus allows for individual modulators 196 and 198 to be addressed and provisioned with the chosen video signal. Each individual modulator corresponding to a specific subscriber video hardware device (primary TV, secondary TV, VCR or the like). As shown, the additional telephony, data and utility modules also reside on the data bus.

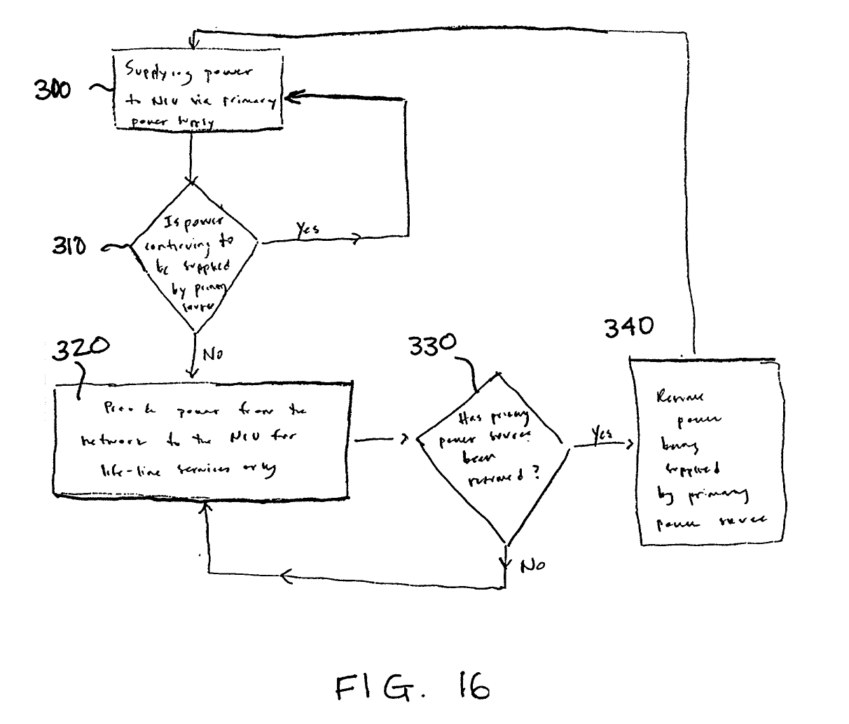

Referring now to FIG. 15, illustrated is a block diagram of the Network Interface Unit 10 and the powering scheme of the present invention used to power the Network Interface Unit 10. In accordance with an embodiment of the present invention, the NIU is provided primary power via the subscriber's facility and back-up power is supplied to “lifeline” utilities (such as the telephone or the like) via the network in the instance where the primary power fails. As shown in normal operation the NIU internal power supply 200 will be provided power from a local power source 210. The NIU, having a physical locale in close proximity to the subscriber's facility may be powered from the facility via low powered reverse feed. A power sensor 220, typically a commercially available solid state sensor, will be located within the NIU in electrical communication with the local power source and the internal power supply. The power sensor serves to detect the loss of power from the subscriber facility electrical system. If the power sensor senses a loss or interruption of power from the local power source it then commands a powering selector switch 230 to select power from a network power source 240. Additionally, the switch, typically a commercially available solid-state switch, will also shutdown power to all non-essential modular components. In this fashion, the network power source will only supply power to those modules deemed “life-line” services (such as telephone services, medical related apparatus or the like). The NIU can be configured on an individual basis via the subscriber management system at the headend to provide “lifeline” back up power to those services/devices which an individual subscriber deems as essential. It should be noted, however, that the power that can be drawn from the network power source is limited and therefore the use of network power during back-up periods should be limited to those services/equipment that are of a “life-line” nature.

The sensor also is capable of sensing the restoration of electrical power at the local power supply and commanding the powering selector switch to return to the normal powering state. Additionally, when the sensor detects a restoration of power the powering sensor switch will power-up those modules that shutdown during the back-up period.

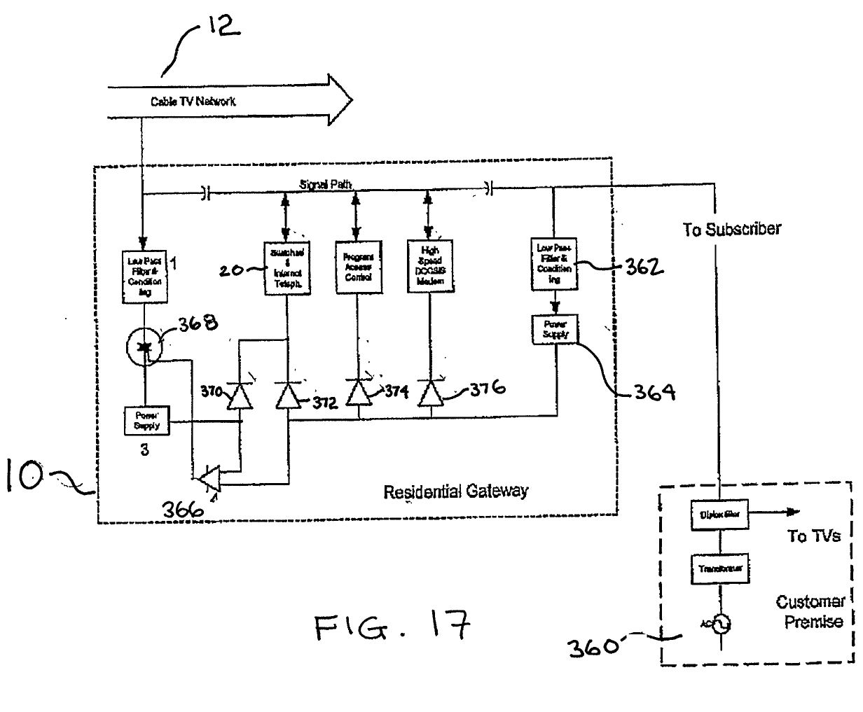

Referring now to FIG. 16, a flow chart illustrating a method for providing power to the NIU in accordance with another embodiment of the present invention. At step 300, the Network Interface Unit is continuously powered by the primary power supply, typically local power supplied at the subscriber's facility. A power sensor serves to monitor the primary power supply's ability to provide the NIU with power. At query 310, if the power sensor continues to sense that power is being provided by the primary power supply then the iterative state of supplying power to the NIU by the local power supply continues (step 300). However, if the power sensor detects a loss of power from the local power then, at step 320, the system provides network power to the Network Interface Unit to support at least the life-line services of the system, such as the telephony services or the like.

At query 330, the power sensor continues to sense the power, or lack thereof, coming from the local power supply. If no power is restored to the local power supply then the iterative state of supplying power to the NIU via the network power source continues (step 320). However, if the local power source is restored, then, at step 340, the system resumes power being supplied by the local power source and all modules/components of the NIU that were shutdown during the back-up period are powered-up, accordingly. Once power is restored to the primary local power source the iterative state of monitoring the power via the sensor continues until a subsequent failure or interruption occurs.

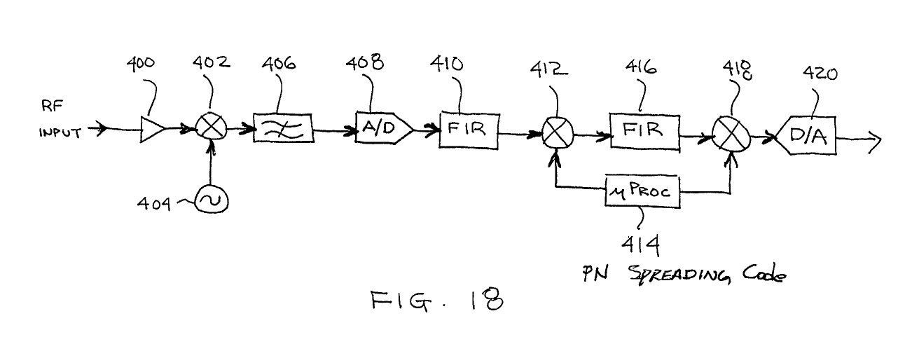

Referring now to FIG. 17, depicted is a circuit diagram of one embodiment of the power sensor and switching mechanism within the NIU of the present invention. The Network Interface Unit 10 is shown incorporated within the context of a HFC Network 12 environment, such as a cable TV network. In a normal state, when the local power source 360 is operational, the Network Interface Unit 10 receives power from local power source. The Network Interface Unit 10 is powered from local power source 360 through the filter and conditioning module 362 leading to the power supply 364.

When power is not present from local power source 360, then a voltage comparator 366 is biased “on” and power is received by the Network Interface Unit by a network power source through HFC Network 12, to power at least the telephony services 20. The voltage comparator 366 is a conventional operational amplifier, which compares the two input voltages. One input is from the local power source and its presence biases the bridge 368, such as a TRIAC diode or the like, “off.” When biased “off,” the network power source is off and the Network Interface Unit draws no power from the network power source. Loss of this input from the local power source switches the bridge 368 “on,” thereby providing power from the network.

The bridge 368 also rectifies the incoming AC voltage from the network power source. A standard cable network is typically powered at 90 volts and a frequency of 60 Hz. Telephone services 18 are typically powered at 90 volts and a frequency of 20 Hz. Thus, the bridge 368 is able to rectify the incoming AC voltage from the network power source so that the telephone service 18 is able to be powered by the network power source.

The steering diodes 370, 372, 374, and 376, control power to the services supported by the Network Interface Unit and allow power to be supplied by the network power source only to those modules or services deemed necessary by the network provider or the subscriber.

Many modifications and other embodiments of the invention will come to mind to one skilled in the art to which the invention pertains having the benefit of the teachings presented in the foregoing descriptions and the associates drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A broadband communications network interface unit for supporting a plurality of services to a residence comprising:
an input module in communication with a network carrying at least one service to a subscriber;
control means in communication with the input module for controlling the network interface;
powering means in communication with the input module and said control module for powering said network interface; and
a program access control module in communication with the input module wherein said program access control module controls the subscribers access to said at least one service.

2. The broadband communications network interface unit of claim 1, further comprising a utility management module in communication with said input module for managing the loads on the network interface.

3. The broadband communications network interface unit of claim 1, further comprising a telephony module in communication with said input module wherein said telephony module provides telephone service to said subscriber.

4. The broadband communications network interface unit of claim 1, further comprising a data module in communication with said input module for providing data services to said subscriber.

5. A broadband communications network interface unit for supporting at least one service to a subscriber comprising:
a primary power supply electrically connected to the network interface unit for supplying power to the plurality of services provided by the network interface unit;
a network power supply electrically connected to the network interface unit for supplying backup power to at least one of the plurality of services supported by the network interface unit;
a power sensor electrically connected to said primary power supply for detecting loss of power from said primary power supply and restoration of power from said primary power source; and
switching means electrically connected to said power sensor for switching the power supplied to the network interface unit from said primary power supply to said network power supply when said power sensor detects a loss of power from said primary power supply and for switching the power supplied to the network interface unit from said network power supply to said primary power supply when said power sensor detects a restoration of power from said primary power supply.

6. A network interface unit according to claim 5, wherein said at least service supported by the network interface unit further comprises at least one service chosen from the group consisting of facsimile service, telephony service, network service, and cable television service.

7. A network interface unit according to claim 5, wherein said network power supply is comprised of power being supplied by a cable television network.

8. A network interface unit according to claim 5, wherein said network power supply provides backup power to at least one of the services supported by the network interface unit wherein the at least one service is telephony service.

9. A network interface unit according to claim 5, wherein said primary power supply is comprised of the subscriber's facility electrical system.

10. A method of providing primary power and backup power to a broadband communications network for providing at least one service to a subscriber, the method comprising:
supplying power to the network interface unit via a primary power supply electrically connected to a facility electrical system;
sensing the loss of power from said primary power supply; and
providing power to at least one service via a network power supply when a loss of power is sensed from said primary power supply.

11. The method according to claim 10, further comprising:
sensing the restoration of power from said primary power supply; and providing power to said at least one service via said primary power supply when restoration of power is sensed from said primary power supply.

12. The method according to claim 10, wherein the primary power supply comprises power being supplied by a facility power source.

13. The method according to claim 10, wherein said at least one service comprises at least one service chosen from the group consisting of facsimile service, telephony service, networking service, and cable television service.

14. The method according to claim 10, wherein said network power supply is comprised of power being supplied by a cable television network.

15. A power switch for a broadband communications network for switching the power supplied to the broadband communications network between a primary power supply and a secondary power supply.

16. A power switch for a broadband communications network having a primary power source and a secondary power source, wherein said power switch comprises:
sensor means for sensing the loss of power from said primary power source;
switching means for switching the power supplied to the broadband communications network from said primary power source to said secondary power source when said sensor means detects a loss of power from said primary power source.
